(19) United States
(12) Patent Application Publication
(10) Pub. No.: US 2002/0087482 A1
(43) Pub. Date: Jul. 4, 2002

(54) Method and information system for verifying electronic shipping-voucher and shipping data

(76) Inventor: Harald Krodel, Sindelfingen (DE)

Correspondence Address: KENYON & KENYON, ONE BROADWAY, NEW YORK, NY, 10004, US

(21) Appl. No.: 10/016,796

(22) Filed: Oct. 26, 2001

(30) Foreign Application Priority Data
Oct. 27, 2000 (DE) 100 53 331.0

(51) Int. Cl. H04K 1/00; H04L 9/00; G06F 17/60

(52) U.S. Cl. 705/75

(57) ABSTRACT

In a method and an information system for verifying electronic shipping-voucher and shipping data sent by a sender (in particular a supplier) to a receiver (in particular a system provider or a plant), faulty data records are automatically detected or recognized and displayed in a defined access area of a central information system. The sender is able to inspect this defined access area, which contains the faulty data records sent by him, and modify the data records it contains. In this manner, the sender receives, on-line, a check-back indication or acknowledgment of the quality of the data records sent by him, and, if indicated, is able to make a correction. The sender's access to his defined access area may occur over the Internet.

### FIELD OF THE INVENTION

The present invention relates to a method for verifying electronic shipping-voucher and shipping data, sent by a sender to an information system, as well as to an information system suited for this purpose.

### BACKGROUND INFORMATION

Most system providers, who manufacture complex products, have at their disposal a wide network of external vendor firms, who supply the system providers with various resources in the form of raw materials, semifinished products, components, and services. These resources are ordered by the system provider—depending on the requirements that arise—from the suppliers and are delivered by the suppliers at a point in time defined by the system provider, to a location specified by the system provider, in one of the manufacturing plants of the system provider. The delivery of a particular order amount, i.e., the shipping of the goods to which the order pertains, is accompanied by a shipping voucher, i.e., by corresponding shipping information sent by the supplier to the system provider. This shipping voucher, i.e., the corresponding shipping information is sent within the system provider firm to the plant or location where the goods are to be delivered. In order for the goods to be received at the proper location, the data contained in the shipping vouchers or in the shipping information must be error-free. The shipping vouchers or the shipping information are largely provided as electronic data records, the format of which is defined by German or international standards (e.g., VDA 4913 for shipping voucher data, VDA 4921 for shipping data).

In one year, a typical system provider collects several hundred thousand shipping vouchers and consignment notes or waybills, which need to be recorded, checked and processed by the plant to which the goods are to be delivered. If the shipping voucher or shipping data are incorrect, then they must be corrected manually. This involves replacing incorrect information or obtaining and adding missing information, thereby necessitating substantial interactive effort. If the received data are irreparable, then a receive report is drawn up, and the data are stored as unusable. The consequence is that, in the case of a delivery, important information pertaining to this delivery is missing, which may lead to considerable extra expenses and time delays (e.g., due to misallocation of the delivered goods).

It is an object of the present invention to provide a method and an information system which will make it possible to substantially reduce the outlay entailed in checking and correcting electronic shipping voucher and shipping data.

### SUMMARY

The above and other beneficial objects of the present invention are achieved by providing a method and device as described herein.

According to one example embodiment of the present invention, the electronic shipping-voucher and shipping-data records sent by a supplier and received by the system provider are first checked by an information system for the presence or absence of errors. If a data record is classified as being error-free, it is then routed to a company receiver (e.g., to the section of the plant where the goods were intended to be delivered). If, on the other hand, the data record is faulty, it is then stored in a defined access area of the information system, where it may be examined by the sender (i.e., by the supplier in question) and revised. The supplier may examine the defined access area to obtain a check-back indication, on-line, as to whether the data sent by him is classified as incorrect. In addition, he has the possibility of revising this incorrect data himself.

At the core of the present invention is the crucial realization that, as a general rule, it is substantially more difficult and expensive for the system provider to correct a faulty shipping-voucher or shipping-data record than it is for the supplier, who created and sent this faulty data record. Thus, the faulty data records may be corrected much more quickly and effectively, insofar as these data records are able to be reflected back or relayed, on-line, to the supplier, and the supplier's corrections are able to be inserted into the data record on-line. Thus, the system provider may realize substantial savings (because the need is eliminated for manually correcting the data records, as is the corresponding outlay for obtaining information). The supplier receives comprehensive information about the legibility of the shipping voucher and shipping information sent by him from the system provider. This knowledge may be used by the supplier to analyze his internal procedures with respect to sources of error in creating the shipping-voucher and shipping-data records and, thus, to selectively reduce the error rate.

The automatic review that a data record sent by the supplier undergoes in the system provider's information system includes a verification that the sender is, in fact, authorized to send. Furthermore, it is checked whether the syntax of the transmitted data record conforms with the agreed-upon standard (e.g., VDA format). The data record may be further checked for conformity with a purchase order, sent by a system provider, who had initiated this delivery, to the supplier in question. This requires that the information system be provided with an interface to a database of the system provider, in which the order information is electronically stored. The order information checked using the information system may include the article number and quantity of the goods to be delivered, the delivery location, etc., i.e., all information which ensures a frictionless receipt of the goods to be delivered at the receiving location of the system provider.

The incoming shipping voucher and shipping data may be checked for errors within the system provider's plant environment at a plant or area-of-operations level. This means that each plant or each area of operations runs its own information system, with whose assistance, the shipping voucher and shipping data relevant to this plant or this area of operations are checked, and the faulty data being collecting in this information system are reflected back or relayed to the supplier. Much more beneficial may be, however, performing this verification on a firm-spanning central information system of the system provider, on which all shipping-voucher and shipping data concerning the system provider are checked and displayed—independently of the plant or area of operations to which the data pertain. This arrangement provides the advantage of enabling the supplier to inspect all faulty data records sent by him to various plants or areas of operation of the system provider, at one single location—namely the defined access area of the central information system—instead of having to search for these data in a combination of various information systems. This arrangement also provides the advantage of enabling the system provider to evaluate all faulty data records relevant to one specific supplier at one central location. From this, profiles of the quality of the data sent by the supplier may be generated and used, in cooperation with the supplier, as a basis for developing measures for improving the quality of the data.

The supplier's access to the defined access area of the information system that concerns him may be performed over the Internet. The supplier may log onto the system provider's information system via a password or a user portal to obtain access (read and write rights) for that defined access area in which the faulty data sent by him are stored.

In addition, the system provider's plants or areas of operation, which are receiving the goods, may be allowed to inspect the faulty data contained in the defined access areas of the central information system. It may occur, namely, that goods are delivered before the corresponding electronic shipping voucher or shipping data stored in the access area are able to be corrected by the supplier. Should such a necessity arise, the plant or area of operations receiving the delivery may examine the defined access area corresponding to this supplier, download the faulty electronic shipping voucher or shipping data relevant to this delivery, manually correct it, and assign it to the delivery that has arrived.

### BRIEF DESCRIPTION OF THE DRAWINGS

FIG. 1 is a schematic view of an information network between a system provider and suppliers.

FIG. 2 is a flow chart illustrating verification of a shipping voucher or shipping data record.

FIG. 3a is a screen display of an operator interface, which may be examined by the supplier, of an information system for a shipping voucher and shipping data illustrating an overview of the transmitted data.

FIG. 3b is a screen display of an operator interface, which may be examined by the supplier, of an information system for a shipping voucher and shipping data illustrating a mask for revising faulty data.

FIG. 3c is a screen display of an operator interface, which may be examined by the supplier, of an information system for a shipping voucher and shipping data illustrating a performance characteristic.

### DETAILED DESCRIPTION

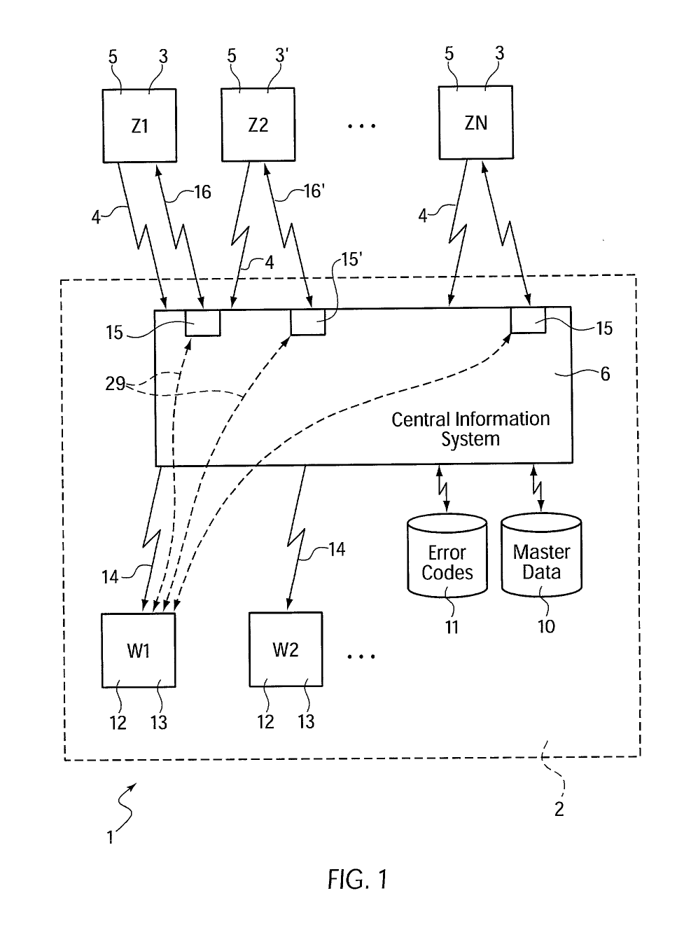

FIG. 1 schematically illustrates an information network 1 between a system provider 2 and a plurality of suppliers 3, 3′. It is used to prepare and further process shipping-voucher and shipping data. Suppliers 3, 3′ send shipping-voucher and shipping data in electronic form (indicated by arrows 4 in FIG. 1) to system provider 2. For this reason, suppliers 3, 3′ are also referred to in the following description as “senders” 4. Both the electronic shipping vouchers, as well as the electronic shipping information are provided in a standardized format (e.g., VDA 4913 or VDA 4921).

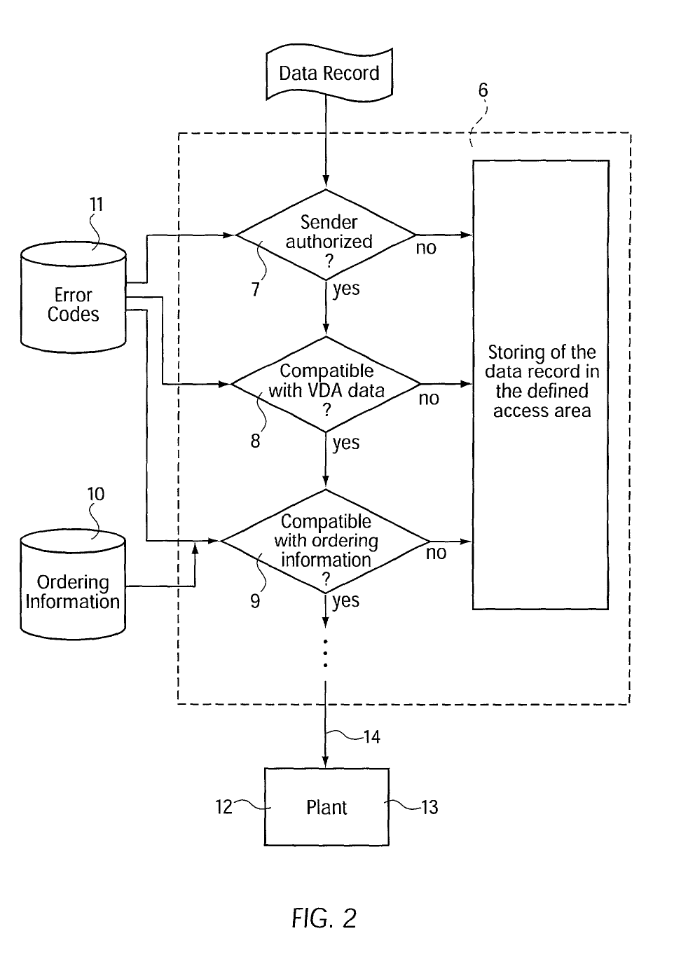

The incoming data are routed to a central information system 6 of system provider 2 and, therein, checked by a test program. This arrangement is illustrated in the schematic flow chart of FIG. 2. In a first step 7, it is checked whether the sender of this data record (i.e., supplier 3, 3′ in question) is authorized to send. If this is not the case, the relevant data record is provided with an error code. In a further step 8, the syntax of the transmitted data record is checked to verify conformity with the agreed upon standard (e.g., VDA format). If the data record does not meet these requirements, it is classified as faulty, and provided with an error code characterizing this error. If the data record does conform with the VDA standard, then the information content of the data record may be interpreted, and the information contained therein is checked in a further review step 9 for its consistency with an order. To this end, central information system 6 accesses a database 10 having master data in which are centrally stored the orders executed by system provider 2. This database 10 is searched to find an order which matches the information contained in the electronic shipping voucher with respect to the order number, the type and quantity of goods to be delivered, and the delivery location, etc. of the delivery. If no such order is found, then the shipping voucher in question is classified as faulty and is provided with an appropriate error code. If desired, the received shipping voucher or shipping data may be subjected to further checks to determine whether the data record in question is classified as faulty or error-free. The specific error codes are stored in a database 11 to which central information system 6 has access.

If the shipping voucher or shipping data record is classified as being faulty in all review steps 7, 8, 9, the data record is then sent to a receiver 12 in that plant 13 and/or that area of operations which, upon arrival, accepts the goods or allocates them to an account (indicated in FIG. 2 by arrows 14). It is, thus, ensured that, in this plant 13 or area of operations, an error-free data record is at hand, which clearly describes the expected delivery and which may be assigned to this delivery by the processors or originators in this plant 13 or area of operations when the goods are received. Since the data record is free of errors, no further (manual or interactive) processing of the data record is necessary in plants 13 or in the areas of operation.

If the shipping-voucher or shipping-data record is classified as being faulty in some test or validation station 7, 8, 9, then the data record is stored in a defined access area 15 of central information system 6. All faulty data records relevant to a specific supplier 3′ are stored, in the process, in a defined access area 15′ assigned to this supplier 3′. Supplier 3′ is granted access rights to the defined access area 15′, in central information system 6, so that he may inspect and revise the data stored in this area 15′. This access may be performed over the Internet. For this, a supplier 3, 3′ logs onto a home page configured for this purpose, for example, or onto an Internet portal of system provider 2, from where he arrives—by entering a password—at defined access area 15, 15′, appropriate for him (indicated in FIG. 1 by arrows, 16, 16′). Supplier 3, 3′ is able to view a display of the data records which are stored therein and identified as faulty (and possibly provided with an error code designating the type of error). Supplier 3, 3′ may modify or correct each of these data records. Once a revision is made to a data record, this data record is again subjected to the verification sequence illustrated in FIG. 2. If, at this point, it is classified as error-free, then—as described above—it is relayed to an appropriate plant 13 or area of operations. If it is still faulty, it is then stored, in turn, in defined access area 15, 15′ assigned to this supplier 3, 3′, so that a renewed correction may be made by supplier 3, 3′.

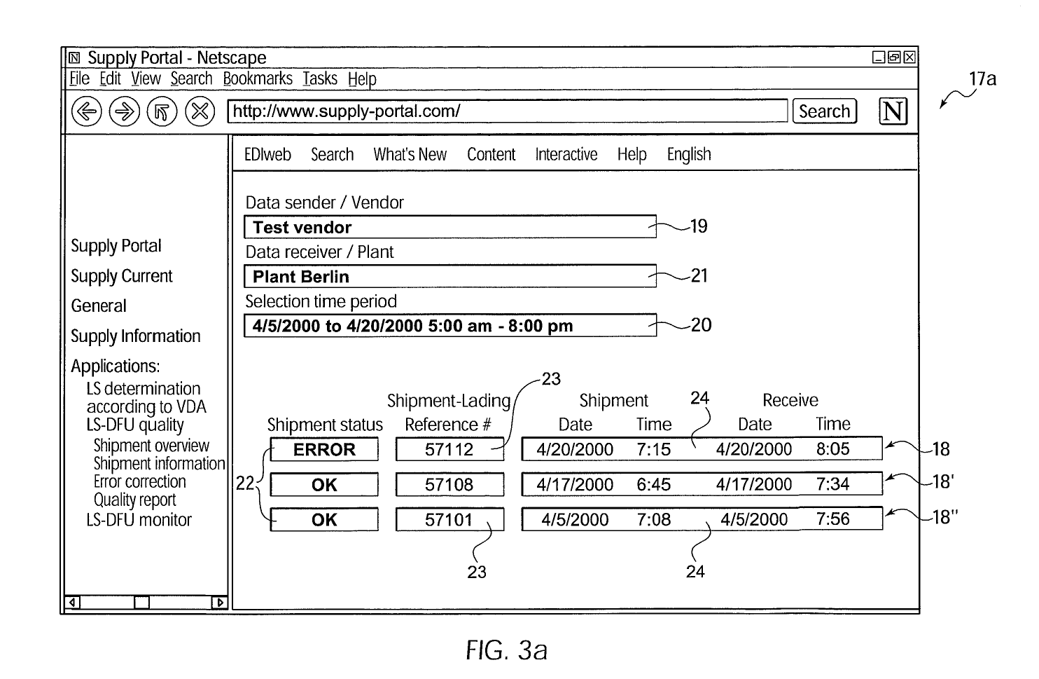

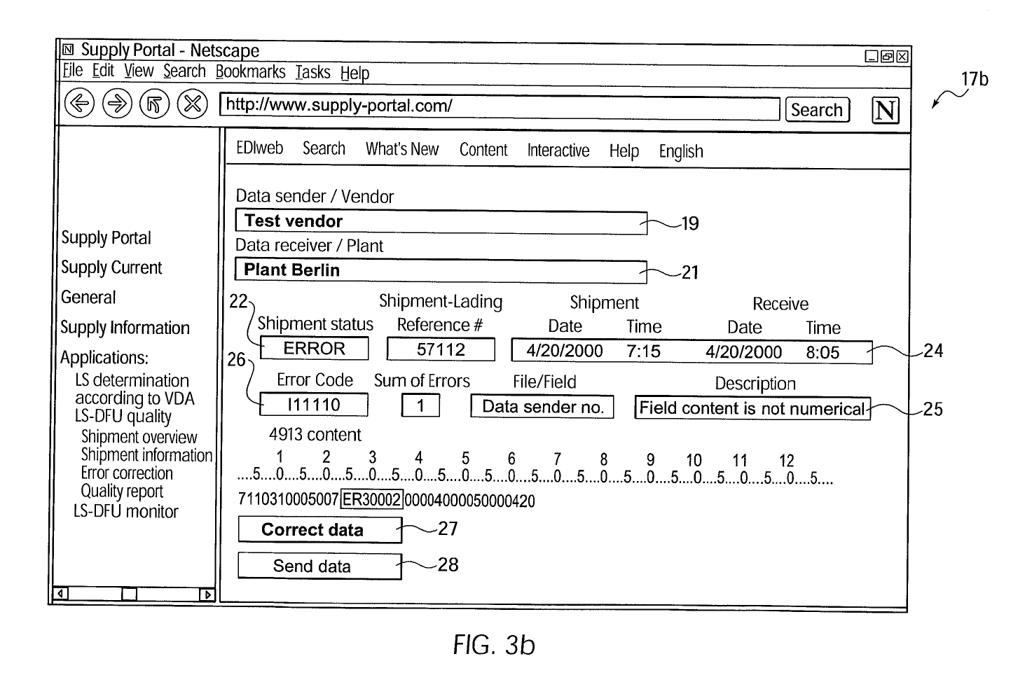

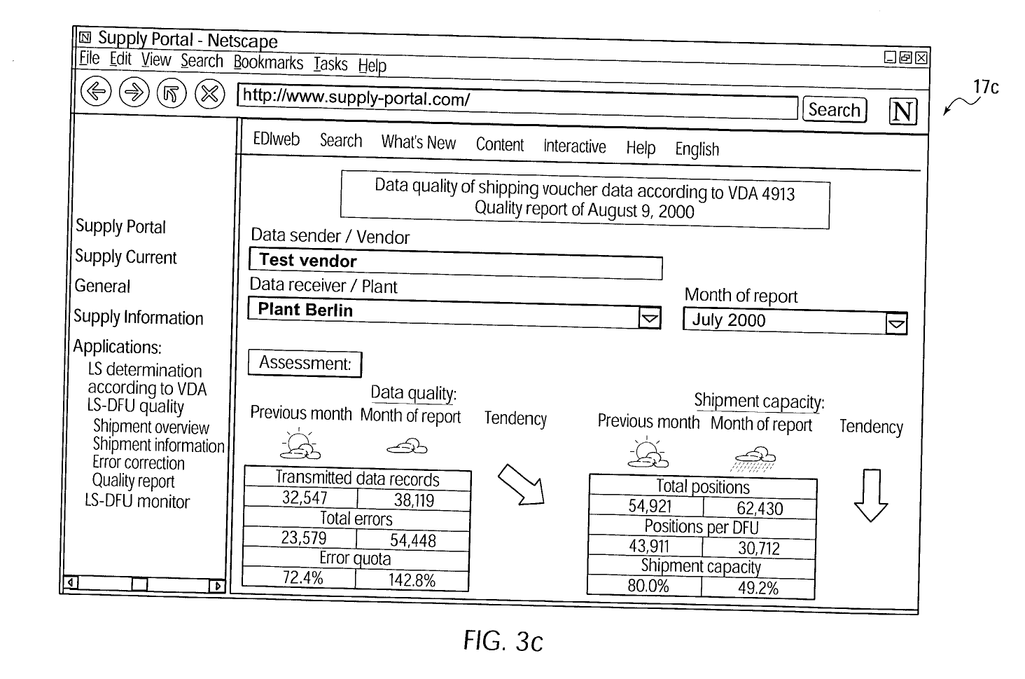

FIGS. 3a to 3c illustrate an example of an implementation of an operator interface 17a, 17b, 17c, which enables a supplier 3′ (“test vendor”), who used a password to arrive at this operator interface 17a, 17b, 17c, to examine and revise the information of his defined access area 15′. FIG. 3a illustrates a schedule of those data records 18, 18′, 18″, which supplier 3′ (“test vendor”), named in data field 19, had sent to system provider 2 in the time period displayed in data field 20 and which are designated for plant 13 (“Berlin”) indicated in data field 21. These are three data records 18, 18′, 18″, of which two (18′, 18″) were classified as error-free (i.e., status “OK” in data field 22), while a data record 18 was classified as faulty (i.e., status “ERROR” in data field 22). For each data record, an internal reference number is given in a data field 23, and the send and receive information is given in data field 24.

Each data record 18, 18′, 18″ may be individually selected by supplier 3′ (“test vendor”). In this manner, supplier 3′ arrives at operator interface 17b (FIG. 3b), in which detailed information is displayed with respect to selected data record 18. In the example illustrated, it is indicated in data field 25 that selected data record 18 contains a syntax error. The corresponding error code is indicated in data field 26. By selecting control button 27 (“correct data”), the supplier arrives in a mode where he may implement changes to the displayed data record 18. Once these revisions are made, he may once again forward modified data record 18 by selecting control button 28 (“send data”) to central information system 6, where—as described above—data record 18 is once again checked.

To evaluate the performance of a supplier 3′ with respect to the error rate of the data sent by him, the number of faulty data records 18 of this supplier 3′ are calculated in relation to the total number of data records sent by this supplier. In addition, the error rate may be analyzed in the various error categories (syntax errors with respect to VDA standard, errors of content, etc.). Periodically updating these error rates enables one to visualize “improvements” or “deteriorations” in the supplier's performance. An example of such a screen display 17c is illustrated in FIG. 3c.

If the faulty or erroneous shipping-voucher or shipping-data records 18 stored in defined access areas 15, 15′ are not corrected quickly enough by suppliers 3, 3′, then it may occur that the delivery associated with this data record arrives in the receiving plant 13 or area of operations before a corrected data record may be sent by the central information system 6 to the involved plant 13 or area of operations. In such a case, in order to have rapid access to a data record describing this delivery—even if it is faulty—plants 13 or the area of operation may have access rights to defined access area 15, 15′ of the suppliers (indicated in FIG. 1 by the dotted-line arrows 29). In this manner, when such a necessity arises, the faulty shipping-voucher or shipping data records may be inspected in access area 15, 15′ of plants 13 or areas of operation, and the (faulty) data record which corresponds to the current delivery may be searched or picked out manually.

In the interest of having an effective interaction with the suppliers and a company-wide, clear and concise display of the faulty data records, for one system provider 2—as illustrated in FIG. 1—it is practical to provide only one single central information system 6, in which faulty data records 18 accumulated over all plants 13, may be checked, managed, and viewed. Alternatively, however, one may also move the central information system to the plant level, thereby giving each plant 13 or area of operations its own central information system.

The method according to the present invention and the system according to the present invention are particularly suited—as described—for exchanging shipping-voucher and shipping data between suppliers and a system provider. In another context, however, the method and the information system according to the present invention may also be suited for use in any processes where a plurality of partners interact by exchanging electronic information, the possibility existing that the exchanged data are faulty.

What is claimed is:

1. A method for verifying electronic data records including at least one of electronic shipping-voucher data and shipping data sent by a sender to an information system, comprising the steps of:
receiving the electronic data record by the information system;
checking the data record by the information system for a presence of errors;
routing the data record to a receiver if the data record is error-free; and
storing the data record in a defined access area of the information system if the data record is faulty, the data record stored in the defined access area being examinable by the sender and revisable.

2. The method according to claim 1, further comprising the step of adjusting information of the data record in accordance with ordering information stored in a database.

3. The method according to claim 1, wherein the checking step is performed for a plurality of at least one of plants and areas of plant operations of a system provider jointly at a single central location.

4. The method according to claim 1, further comprising the steps of:
analyzing a number and a type of errors of faulty data records contained in the defined access area with respect to development over time; and
displaying information in the defined access area in accordance with the analyzing step.

5. An information system for verifying electronic data records containing at least one of electronic shipping-voucher data and shipping data sent by a sender to the information system, comprising:
a first interface configured to receive a transmitted electronic data record;
a processing unit configured to recognize a faulty data record;
a defined access area configured to store the faulty data record, the data records contained in the defined access area being inspectable and revisable by the sender; and
a second interface configured to route a faulty data record to a receiver.

6. The information system according to claim 5, further comprising a third interface to a database containing order information.

7. The information system according to claim 5, wherein the data records contained in the defined access area are inspectable and revisable by the sender via the Internet.

8. The information system according to claim 5, wherein the faulty data records stored in the defined access area are inspectable by the receiver.

9. The information system according to claim 5, wherein the data records contained in the defined access area are inspectable and revisable by the sender via a data network.
